(19) United States
(12) Patent Application Publication
(10) Pub. No.: US 2016/0180722 A1
(43) Pub. Date: Jun. 23, 2016

(54) SYSTEMS AND METHODS FOR SELF-LEARNING, CONTENT-AWARE AFFECT RECOGNITION

(71) Applicant: Intel Corporation, Santa Clara, CA (US)

(72) Inventors: RAANAN YEHEZKEL, Kiryat Ekron (IL); DAVID STANHILL, Hoshaya (IL); EYAL ROND, Sunnyvale, CA (US)

(73) Assignee: Intel Corporation, Santa Clara, CA (US)

(21) Appl. No.: 14/578,623

(22) Filed: Dec. 22, 2014

(51) Int. Cl. G09B 5/00; G09B 19/00

(52) U.S. Cl. CPC G09B 5/00; G09B 19/00

(57) ABSTRACT

Systems and methods are disclosed for determining an affective state of a user. A user behavior characteristic is detected in response to content provided to the user. Content metadata indicates a context of the content provided to the user and a probability of the user experiencing at least one expected emotion in response to an interaction with the content. Based on the context and the at least one expected emotion indicated in the content metadata, one or more rules are applied to map the detected user behavior characteristic to an affective state of the user.

### TECHNICAL FIELD

The present disclosure generally relates to affect or emotion recognition, and more particularly to recognizing an affect or emotion of a user who is consuming content and/or interacting with a machine.

### BACKGROUND

When a user consumes content and/or interacts with a machine, the interaction generally includes a human action through a common interface (e.g., keyboard, mouse, voice, etc.), and a machine action (e.g., display an exercise having a specific difficulty level in an e-learning system). Human actions may be the result of the user's cognitive state and affective state (e.g., happiness, confusion, boredom, etc.). A cognitive state may be defined, at least in part, by the user's knowledge and skill level, which can be inferred from the user's actions (e.g., score in an e-learning exercise). However, it can be difficult to determine the user's affective state.

### BRIEF DESCRIPTION OF THE DRAWINGS

FIG. 1 is a block diagram of a system for determining an affective state of a user according to one embodiment.

FIG. 2 is a graph illustrating results of an experiment conducted in a classroom using the system shown in FIG. 1 according to one embodiment.

FIG. 3 is a block diagram of an affective state recognition module according to one embodiment.

FIG. 4 graphically illustrates example content and associated content metadata for processing by the content metadata parser shown in FIG. 3 according to one embodiment.

FIG. 5 illustrates a timeline of a learning exercise session in an e-learning system according to one embodiment.

FIG. 6 is a block diagram of an online learning module according to one embodiment.

FIG. 7 is a flow chart of a method for determining an affective state of a user according to one embodiment.

### DETAILED DESCRIPTION OF PREFERRED EMBODIMENTS

One or more sensors may be used to capture the behavior of a user who is consuming content or otherwise interacting with a machine. For example, pulse sensors can be used to determine changes in the user's heart rate, and/or one or more cameras can be used to detect hand gestures, head movements, changes in eye blink rate, and/or changes in facial expression. Such cameras may include, for example, three-dimensional (3D), red/green/blue (RGB), and infrared (IR) cameras. To recognize the underlying affective-states and emotions that are demonstrated in the user's behavior (e.g., appearance and/or actions), an automated system may be used to analyze behavior such as facial expressions, body language, and voice and speech analysis (e.g., using text and/or natural language processing (NLP)). However, there are problems in designing such a system.

For example, it is difficult to predefine affective-states and/or emotions based on behavior because it may not be clear what meaning should be applied to a state without a contextual understanding of the user's situation (e.g., happiness in a gaming environment may not be the same as happiness in an e-learning environment). It may also be difficult to define affective-states and/or emotions because it is not predetermined how long an affective state should last (e.g., surprise vs. happiness) and there may be a general lack of knowledge about the underlying mechanisms of emotions and cognition.

There is also a lack of labeled data for training a system (e.g., machine learning). It is a difficult task to obtain emotion labels for recorded human behavior. Judging which emotions are expressed at a particular time may be subjective (e.g., different observers may judge differently) and the definition of any affective state can be ambiguous (as perceived by humans). Also, predefining a set of affective states to be labeled may limit the solution, while adding more affective states in later stages of system development or use may require additional development effort.

It may also be difficult to design an automated system because a specific affective state may be expressed in a variety of behaviors. This is due to differences in personality, culture, age, gender, etc. Behavioral commonalities are limited (e.g., Ekman's six basic facial expressions). Thus, relying on preconceived commonalities may significantly limit the range of recognizable affective states.

Embodiments described herein recognize that manifestations of a person's emotions are context based. Thus, contextual data associated with the content consumed by a user and/or the interaction between the user and a machine is used to analyze the user's behavior. Certain embodiments automatically learn on-the-fly, to map human behavior to a varying range of affective-states while users are consuming content and interacting with a machine. For example, an automated system may be used to dynamically adapt to a real world scenario such as recognizing a user's stress level while playing a computer game, recognizing the engagement level of a student while using an e-learning system, or recognizing the emotional reactions of a person while watching a movie or listening to music. Such embodiments are contrary to the practice of training a system in a factory by hardcoding the system to recognize a predefined set of emotions using a large amount of pre-collected labeled data.

In certain embodiments, the system uses an expected difference in humans' emotional reactions to different content under the same context and/or application. For example, the probability is higher than a chance (e.g., greater than 50%) that a student may feel more confused when given a tricky question compared to when given a simple question. Thus, the system factors in this probability when detecting a user's behavior that is consistent with confusion. The system may not rely on all expected differences to be actually evident, but rather updates the expected differences over time as more user behavior is collected and analyzed.

In certain embodiments, the system associates an expected difference in emotions with an expected difference in behavior. The system measures and compares features of behavior (e.g., facial expressions, voice pitch, blink rate, etc.) and generates a mapping from behavior to emotions (as described below).

In addition, or in other embodiments, the system uses content metadata as a reference for the expected differences in emotions. The content metadata, which may be generated by the content creator (e.g., movie director, musician, game designer, educator, application programmer, etc.), describes the content and includes prior belief about how humans are expected to react to different content types and/or particular portions of the content. Thus, the metadata defines which emotions should or can be recognized by the machine. Moreover, ambiguities in the definitions of emotions and/or affective-states are resolved on a case-by-case basis by the content creators and not by the engineers in the factory.

Example embodiments are described below with reference to the accompanying drawings. Many different forms and embodiments are possible without deviating from the spirit and teachings of the invention and so the disclosure should not be construed as limited to the example embodiments set forth herein. Rather, these example embodiments are provided so that this disclosure will be thorough and complete, and will convey the scope of the invention to those skilled in the art. In the drawings, the sizes and relative sizes of components may be exaggerated for clarity. The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

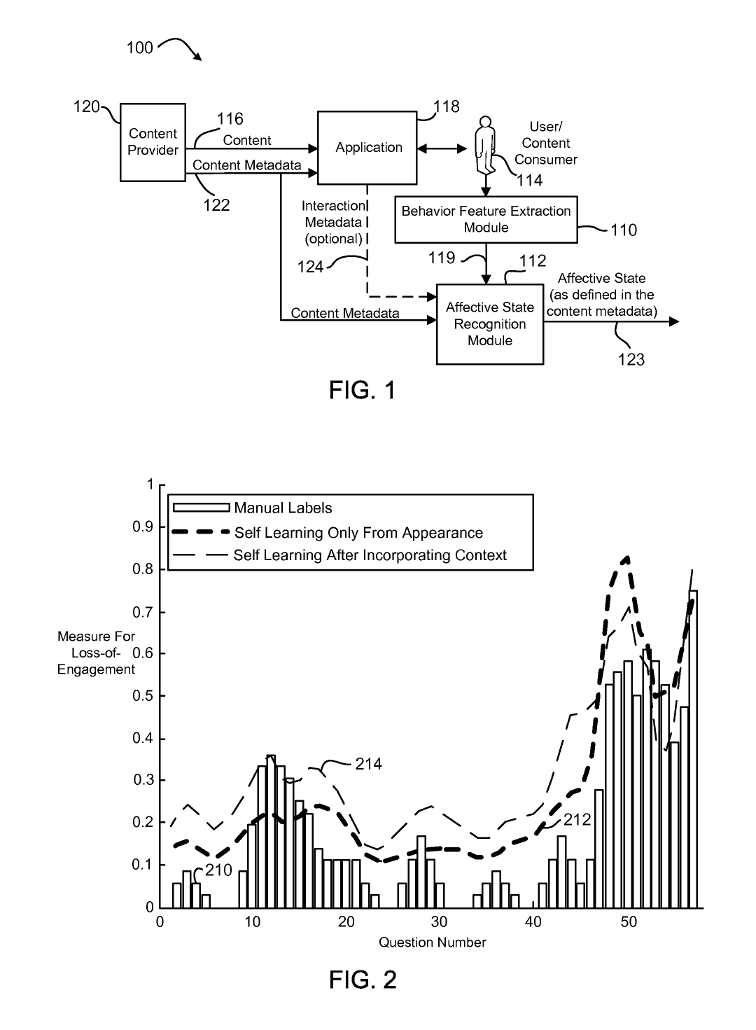

FIG. 1 is a block diagram of a system 100 for determining an affective state of a user according to one embodiment. The system 100 includes a behavior feature extraction module 110 and an affective state recognition module 112. The behavior feature extraction module 110 is configured to observe a user 114 consuming content 116 through an application 118 or otherwise interacting with a device or machine (not shown) hosting the application 118. The behavior feature extraction module 110 detects visual cues or characteristics of the user's behavior (e.g., facial features, head position and/or orientation, gaze point, blink rates, eye movement patterns, etc.), associates the detected behavior feature with a portion or segment of the content 116 viewed by the user 114, and communicates the detected behavior features as user behavior characteristics 119 to the affective state recognition module 112.

As the user 114 views the content 116 and/or otherwise interacts with the application 118, the user 114 may experience a series of emotional states. Examples of emotional states may include happiness, sadness, anger, fear, disgust, surprise and contempt. In response to these emotional states, the user 114 may exhibit visual cues including facial features (e.g., location of facial landmarks, facial textures), head position and orientation, eye gaze and eye movement pattern, or any other detectable visual cue that may be correlated with an emotional state. Not all emotional states may be detected from visual cues and some distinct emotional states may share visual cues while some visual cues may not correspond to emotional states that have a common definition or name (e.g., a composition of multiple emotions or an emotional state that is between two or more emotions, such as a state between sadness and anger or a state that is composed of both happiness and surprise). The system 100 may therefore be configured to estimate pseudo emotions which represent any subset of emotional states that can be uniquely identified from visual cues.

In certain embodiments, a content provider 120 provides content metadata 122 to indicate expected emotions for the content 116, or for different portions or segments of the content 116. The affective state recognition module 112 receives the content metadata 122, which provides context when analyzing the user behavior characteristics 119 provided by the behavior feature extraction module 110. As discussed below, the affective state recognition module 112 applies rules to map the detected behavior features to emotions based on the expected emotions indicated in the content metadata 122. The affective state recognition module 112 outputs the user's estimated affective state 123, as defined in the content metadata 122.

In certain embodiments, the application 118 also provides interaction metadata 124 that the affective state recognition module 112 uses to estimate the affective state 123. The interaction metadata 124 indicates how the user 114 interacts with the application 118 and may indicate, for example, whether questions are answered correctly or incorrectly, a time when a question is presented to the user, an elapsed time between receiving answers to questions, skipped songs in a playlist, skipped or re-viewed portions of a video, user feedback, or other input received by the application 118 from the user 114.

The affective state recognition module 112 allows the system 100 to learn on-the-fly, to dynamically adapt in a real world scenario. This is contrary to the practice of training a system in the factory by hardcoding it to recognize a predefined set of emotions using a large amount of pre-collected labeled data. Existing solutions are limited to a predefined set of emotion classes. Extending the predefined set to support more emotions/affective states usually requires additional research and development (R&D) efforts. Another limitation of existing solutions is that they do not have a natural way to use contextual information. For example, while watching a movie, they do not rely on the type of currently displayed scene (scary/dramatic/funny).

As disclosed herein, the affective state recognition module 112 learns on-the-fly, in a bootstrap manner, to both define and recognize a range of human emotions and/or affective states. Such embodiments are more useful than solutions that are factory pre-learned to recognize a limited set of predefined behaviors (e.g., facial expressions), where these behaviors may be (mostly) wrongly assumed to indicate a single emotion. Due to the bootstrap nature of the learning algorithm of the affective state recognition module 112, the system 100 learns to map any behavior to any emotion. This results in a personalized mapping where no assumptions are made about links between any behavior and any emotion. Rather, mapping of behavior to emotion is made in each case based on situational context provided by the content metadata 122 and, in certain embodiments, by the interaction metadata 124.

In certain embodiments, the system 100 constantly improves itself and adjusts to slow and gradual changes in a specific person's behavior. For example, in an intelligent tutoring system embodiment, the system 100 can monitor not only the achievements of the student but also how the student “feels” and the system moderates the content accordingly (e.g., change difficulty level, provide a challenge, embed movies and games, etc.). FIG. 2 is a graph illustrating results of an experiment conducted in a classroom using the system 100 according to one embodiment. The x-axis of the graph corresponds to the question number presented to the student, and the y-axis corresponds to a measure for loss of engagement (a lower number indicating that the student is more engaged). The vertical bar graphs 210 correspond to manual human labeling of a student's engagement with test questions, averaged over the labeling of several observers including the student's class teacher and a pedagogue. A graph 212 shows the results of self-learning only from the appearance of the student. A graph 214 shows the results of self-learning after incorporating context into the analysis using the system 100 to determine the student's level of engagement with the test questions. As compared to the results shown in the graph 212, the graph 214 shows that incorporating context allows the system 100 to measure the loss of engagement more consistent with the manual labels provided by the human observers. As the student starts to experience more loss of engagement (e.g., around questions forty-eight to fifty), the system 100 may adjust to provide more engaging questions (e.g., such as those around question twenty that the student found to be more engaging).

Persons skilled in the art will recognize that the behavior feature extraction module 110, affective state recognition module 112, and application 118 may be on the same device, computer, or machine. In addition, or in other embodiments, at least one of the behavior feature extraction module 110 and the affective state recognition module may be part of the application 118. In other embodiments, at least one of the behavior extraction module 110 and the affective state recognition module 112 may be on a different device, computer, or machine than that of the application 118. In certain embodiments, the content 116 and/or content metadata 122 is stored on the device, computer, or machine hosting the application 118. While in other embodiments, the content 116 and/or content metadata 122 is streamed over the Internet or other network from the content provider 120 to the device, computer, or machine hosting the application 118.

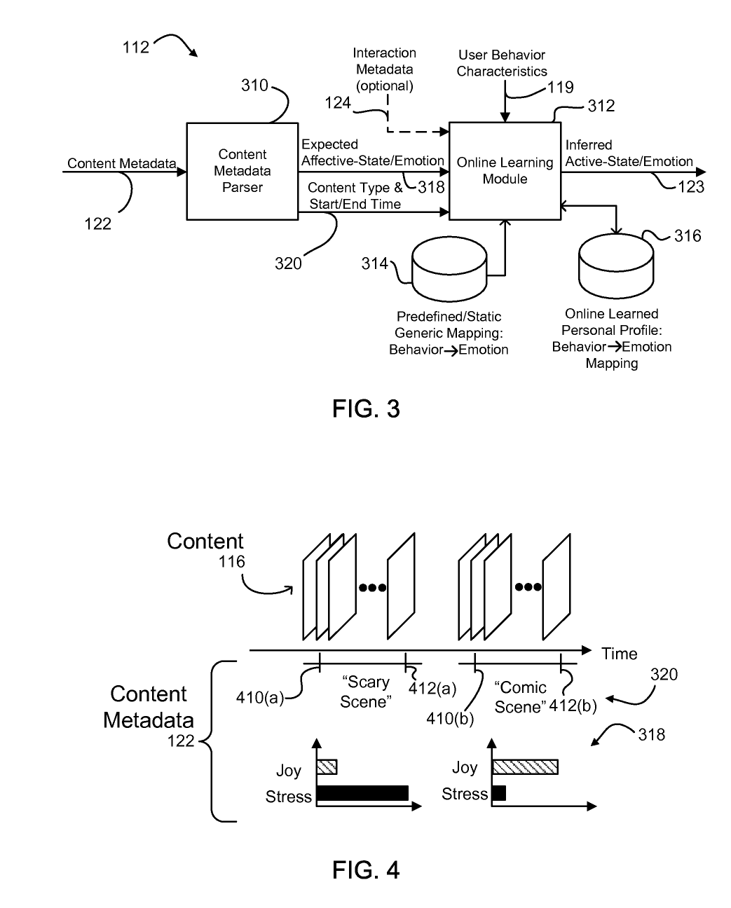

FIG. 3 is a block diagram of an affective state recognition module 112 according to one embodiment. The affective state recognition module 112 shown in FIG. 3 may be used, for example, as the affective state recognition module 112 shown in FIG. 1. The affective state recognition module 112 shown in FIG. 3 includes a content metadata parser 310, an online learning module 312, a first database 314 comprising predefined or static behavior-to-emotion mapping rules, and a second database 316 comprising user profiles including personalized emotion maps. The content metadata parser 310 receives and parses the content metadata 122 into a set of expected affective state and/or emotion labels 318, and a set of content types 320 with associated content timeframes (e.g., start and end times associated with different portions of the content 116). The set of expected affective state and/or emotion labels 318 are also associated with a probability within each content timeframe.

For example, FIG. 4 graphically illustrates example content 116 and associated content metadata 122 for processing by the content metadata parser 310 shown in FIG. 3 according to one embodiment. In this example, the content 116 includes a plurality of video frames (e.g., corresponding to a movie), and the content metadata 122 includes a set of content types 320 with associated start times 410(a), 410(b) and stop times 412(a), 412(b). Persons skilled in the art will recognize from the disclosure herein that means other than start and stop times (e.g., start and stop frames, scene names, or any other content identifiers) can be used to identify portions of the content 116 associated with a content type and corresponding expected affective state or emotion. As shown, the set of content types 320 identifies a first sequence of video frames as a “scary scene” and a second sequence of video frames as a “comic scene.” For each portion of the content 116 associated with a content type 320, the content metadata 122 also includes a set of expected affective state and/or emotion labels 318 (e.g., joy, stress) with corresponding expected probabilities or distributions. In this example, there is a much higher probability that the user will experience stress during the “scary scene” and joy during the “comic scene.”

Returning to FIG. 3, the set of expected affective states and/or emotion labels 318 is used as a target for inference by the affective state recognition module 112. Thus, the target states to be recognized are not “hardwired” in the factory. The content metadata 122 may be generated, for example, by the content creator (movie directors, musicians, game designers, pedagogues, etc.), but can be generated by other means as well (e.g., self-reports of users, control-groups, etc.). It should be noted that the level of detail of the content metadata 122 can vary depending on the application and content provider 120. In certain embodiments, as explained below, a transductive phase is included in the system that can be initialized even with a partial set of content metadata 122.

The online learning module 312 is configured to receive the user behavior characteristics 119 (e.g., from the behavior feature extraction module 110 shown in FIG. 1), the set of expected affective state and/or emotion labels 318, and the set of content types 320 with associated content timeframes. The online learning module 312 is also configured to access the first database 314 and the second database 316. As discussed in detail below, the online learning module 312 observes user behavior and to learn to recognize emotions by monitoring the content to which the user is exposed and the expected affective-states and/or emotions as described in the accompanying content metadata 122. Starting from the predefined behavior-to-emotion mapping rules (e.g., known rules from psychological studies or by global offline training the system) of the first database 314, the online learning module 312 learns a unique mapping for the specific user that it stores in the second database 316.

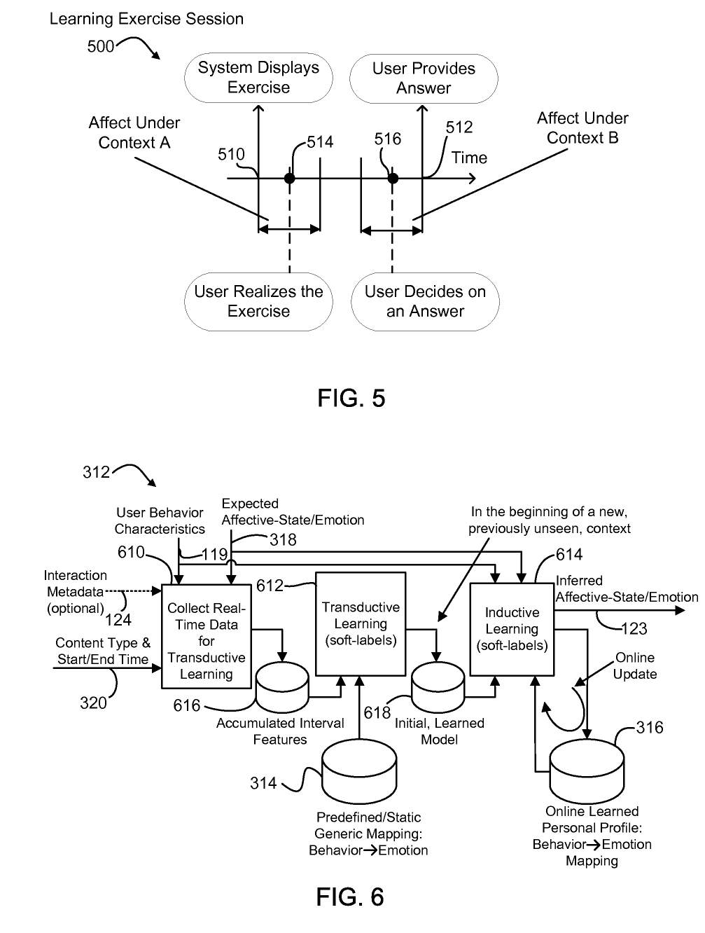

In certain embodiments, the online learning module 312 is also configured to receive the (optional) interaction metadata 124 (shown as a dashed line in FIG. 1 and FIG. 3). The interaction metadata 124 may define, within each content interval, contextual sub-divisions. For example, FIG. 5 illustrates a timeline of a learning exercise session 500 in an e-learning system according to one embodiment. The interaction metadata 124 from the e-learning system may indicate a content interval corresponding to an elapsed time between a first time 510 when the system displays an exercise to the user (e.g., student) and a second time 512 when the user provides an answer. The online learning module 312 may use the first time 510 and the second time 512 to define context “A” sub-interval for “understanding the problem” and context “B” sub-interval for “trying to solve” the problem. The divisions between context “A” and context “B” sub-intervals may, for example, be deduced from expected times for understanding and solving the problem, or from further interaction between the user and the system. Defining different expected affects for context “A” and context “B” allows the online learning module 312 to confine its analysis to a narrower context to achieve higher accuracy. That is, a different set of emotions may be considered under different context. For example, at a time 514 when the “user realizes the exercise” there may be a high probability (e.g., greater than 50%) that observed user behavior corresponds to a “surprise” emotion, whereas at a time 516 when the “user decides on an answer” there may be a high probability (e.g., greater than 50%) that observed user behavior corresponds to a “eureka-moment” emotion.

FIG. 6 is a block diagram of an online learning module 312 according to one embodiment. The online learning module 312 shown in FIG. 6 may be used, for example, as the online learning module 312 shown in FIG. 3. The online learning module 312 shown in FIG. 6 includes a real-time data collection module 610, a transductive learning module 612, and an inductive learning module 614. The online learning module 312 includes a transductive phase and an inductive phase. The transductive phase is a “burn-in” phase that includes the real-time data collection module 610 and the transductive learning module 612. The transductive stage is an initial stage, at the beginning of a new, previously unseen context. At this stage the system does not output an inferred affective-state or emotion 123. However, in other embodiments, the transductive stage may be configured to perform inference based only on predefined models, as in “traditional” systems.

The real-time data collection module 610 is configured to receive and process the user behavior characteristics 119, the set of expected affective-state or emotion labels 318, and the set of content types 320 with associated content timeframes. In certain embodiments, the real-time data collection module 610 also receives and processes the interaction metadata 124. The real-time data collection module 610 outputs accumulated interval features 616 that includes informative data (e.g., behavior features and expected emotion priors) and ignores redundant and uninformative data and/or frames. In one embodiment, for example, the real-time data collection module 610 uses a vector quantization algorithm to process the received data and produce the accumulated interval features 616.

The transductive learning module 612 receives the accumulated interval features 616 and the behavior-to-emotion mapping rules from the first database 314 shown in FIG. 3, and performs transductive learning to generate an initial model 618 for emotion mapping. The transductive learning module 612 is configured to learn a model for mapping behavior to emotions using machine learning algorithms, such as transductive support vector machine (SVM) learning and label-propagation semi-supervised learning (SSL). Persons skilled in the art will recognize that other machine learning algorithms can also be used. The initial model 618 may be an “improved version” of the accumulated interval features 616. In certain embodiments, the transductive learning module 612 outputs the initial model 618 when a new or previously unseen context is encountered. In such embodiments, previously stored initial models 618 may be used for a previously encountered context.

The inductive learning module 614 is configured to perform the second phase (or inductive phase) of the online learning module 312. The inductive learning module 614 receives the user behavior characteristics 119, the set of expected affective-state or emotion labels 318, the initial model 618, and the user profile including the personalized emotion map stored in the second database 316 shown in FIG. 3. The inductive learning module 614 constantly uses new data (e.g., the user behavior characteristics 119 and the and the set of expected affective-state or emotion labels 318) to fine-tune the model (starting from the initial model 618) to produce the personalized emotion mapping, which may be updated in the second database 316. Based on the new data and updated emotion map, the inductive learning module 614 uses machine learning algorithms to determine and output the user's estimated affective state 123.

Thus, the online learning module 312 allows content providers to define content metadata 122 that improves the performance of emotion aware systems for a variety of applications including, for example, e-learning, gaming, movies, and songs. The embodiments disclosed herein may allow for standardization in emotion-related metadata accompanying “emotion inducing” content that may be provided by the content creator (movie directors, musicians, game designers, pedagogues, etc.).

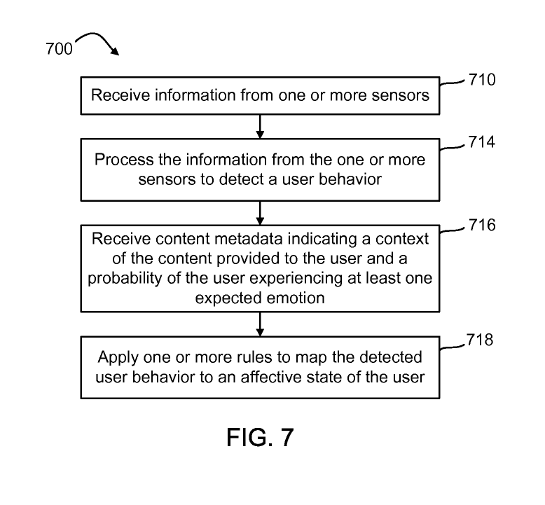

FIG. 7 is a flow chart of a method 700 for determining an affective state of a user according to one embodiment. The method 700 includes receiving 710 information from one or more sensors, and processing (e.g., on one or more computing devices) the information from the one or more sensors to detect a user behavior as the user consumes content or interacts with a machine. The method 700 further includes receiving 716 content metadata indicating a context of the content provided to the user and a probability of the user experiencing at least one expected emotion as the user consumes the content or interacts with the machine. Based on the context and the at least one expected emotion indicated in the content metadata, the method 700 further includes applying 718 one or more rules to map the detected user behavior to an affective state of the user.

### Examples

The following are examples of further embodiments. Examples may include subject matter such as a method, means for perming acts of the method, at least one machine-readable medium including instructions that, when performed by a machine cause the machine to perform acts of the method, or of an apparatus or system for improving input to a mobile device according to the embodiments and examples described herein.

Example 1 is a system to determine an affective state of a user. The system includes a behavior feature extraction module to process information from one or more sensors to detect a user behavior characteristic. The user behavior characteristic may be generated in response to content provided to the user. The system also includes an affective state recognition module to receive content metadata indicating a context of the content provided to the user and a probability of the user experiencing at least one expected emotion in response to an interaction with the content. Based on the context and the at least one expected emotion indicated in the content metadata, affective state recognition module is also configured to apply one or more rules to map the detected user behavior characteristic to an affective state of the user. The affective state recognition module may also output or store the affective state of the user.

Example 2 includes the subject matter of Example 1, wherein the affective state recognition module is further configured to receive interaction metadata indicating an interaction between the user and an application or machine configured to present the content to the user. Based on the interaction metadata, he affective state recognition module may also update the rules to map the detected user behavior characteristic to the affective state.

Example 3 includes the subject matter of any of Examples 1-2, wherein the content comprises a plurality of content intervals, and wherein the interaction metadata defines contextual sub-divisions within the content intervals.

Example 4 includes the subject matter of any of Examples 1-3, wherein the affective state recognition module comprises a content metadata parser to receive the content metadata, and to separate the content metadata into a set of expected affective state and/or emotion labels, and a set of content types with associated content timeframes, and wherein the set of expected affective state and/or emotion labels are associated with a probability within each content timeframe.

Example 5 includes the subject matter of Example 4, wherein the affective state recognition module further comprises a learning module configured to receive data comprising the user behavior characteristic, the set of expected affective state and/or emotion labels, and the set of content types with associated content timeframes. The affective state recognition module may also be configured to process the received data to modify predefined behavior-to-emotion mapping rules to generate a profile for the user comprising a personalized emotion map, and apply the personalized emotion map to the detected user behavior characteristic and the at least one expected emotion to infer the affective state of the user.

Example 6 includes the subject matter of Example 5, wherein the learning module is further configured to update the personalized emotion map based on the detected user behavior characteristic and the at least one expected emotion.

Example 7 includes the subject matter of Example claim 5, wherein the learning module is configured to execute a transductive learning phase. The learning module may further include a real-time data collection module to process the user behavior characteristics, the set of expected affective-state or emotion labels, and the set of content types with associated content timeframes using a vector quantization algorithm to generate accumulated interval features. The learning module may further include a transductive learning module to generate an initial model for emotion mapping. The transductive learning module may use a transductive learning algorithm to process the accumulated interval features and the behavior-to-emotion mapping rules.

Example 8 includes the subject matter of Example 7, wherein the learning module is further configured to execute an inductive learning phase. The learning module may further include an inductive learning module to update the personalized emotion map using a machine learning algorithm to process the initial model generated by the transductive learning module, the user behavior characteristics, and the set of expected affective-state and/or emotion labels.

Example 9 is a computer-implemented method of determining an affective state of a user. The includes receiving information from one or more sensors, and processing (e.g., on one or more computing devices) the information from the one or more sensors to detect a user behavior as the user consumes content or interacts with a machine. The method further includes receiving content metadata indicating a context of the content provided to the user and a probability of the user experiencing at least one expected emotion as the user consumes the content or interacts with the machine. Based on the context and the at least one expected emotion indicated in the content metadata, the method applies one or more rules to map the detected user behavior to an affective state of the user.

Example 10 includes the subject matter of Example 9, wherein receiving the content metadata comprises receiving the content metadata from a provider of the content.

Example 11 includes the subject matter of any of Examples 9-10, wherein the method further includes receiving interaction metadata indicating an interaction between the user and an application configured to present the content to the user. Based on the interaction metadata, the method may further include updating the rules to map the detected user behavior to the affective state.

Example 12 includes the subject matter of Example 11, wherein the method further includes processing the interaction metadata to determine a plurality of contextual sub-divisions within content intervals of the content.

Example 13 includes the subject matter of any of Examples 9-13, wherein the method further includes parsing the content metadata into a set of expected affective state and/or emotion labels, and a set of content types with associated content timeframes. The set of expected affective state and/or emotion labels may be associated with a probability within each content timeframe.

Example 14 includes the subject matter of Example 13, wherein the method further includes receiving data comprising the user behavior, the set of expected affective state and/or emotion labels, and the set of content types with associated content timeframes. The method may further include processing the received data to modify predefined behavior-to-emotion mapping rules to generate a profile for the user comprising a personalized emotion map, and applying the personalized emotion map to the detected user behavior and the at least one expected emotion to infer the affective state of the user.

Example 15 includes the subject matter of Example 14, wherein the method further includes executing a transductive learning phase comprising: processing the user behavior, the set of expected affective-state or emotion labels, and the set of content types with associated content timeframes using a vector quantization algorithm to generate accumulated interval features; and generating an initial model for emotion mapping using a transductive learning algorithm to process the accumulated interval features and the behavior-to-emotion mapping rules.

Example 16 includes the subject matter of Example 15, wherein the method further includes executing an inductive learning phase comprising updating the personalized emotion map using a machine learning algorithm to process the initial model, the user behavior, and the set of expected affective-state and/or emotion labels.

Example 17 is at least one computer-readable storage medium having stored thereon, the instructions when executed on a machine cause the machine to perform the method of any of Examples 9-16.

Example 18. An apparatus comprising means to perform a method as claimed in any of Examples 9-16.

Example 19 is at least one computer-readable storage medium having stored thereon instructions that, when executed by a processor, cause the processor to perform operations comprising: receiving information from one or more sensors; processing, on one or more computing devices, the information from the one or more sensors to detect a user behavior as the user consumes content or interacts with a machine; receiving content metadata indicating a context of the content provided to the user and a probability of the user experiencing at least one expected emotion as the user consumes the content or interacts with the machine; based on the context and the at least one expected emotion indicated in the content metadata, applying one or more rules to map the detected user behavior to an affective state of the user.

Example 20 includes the subject matter of Example claim 19, wherein receiving the content metadata comprises receiving the content metadata from a provider of the content.

Example 21 includes the subject matter of any of Examples 19-20, the operations further comprising: receiving interaction metadata indicating an interaction between the user and an application configured to present the content to the user; and based on the interaction metadata, updating the rules to map the detected user behavior to the affective state.

Example 22 includes the subject matter of Example 21, the operations further comprising: processing the interaction metadata to determine a plurality of contextual sub-divisions within content intervals of the content.

Example 23 includes the subject matter of any of Examples 19-22, the operations further comprising: parsing the content metadata into a set of expected affective state and/or emotion labels, and a set of content types with associated content timeframes, wherein the set of expected affective state and/or emotion labels are associated with a probability within each content timeframe.

Example 24 includes the subject matter of Example 23, the operations further comprising: receiving data comprising the user behavior, the set of expected affective state and/or emotion labels, and the set of content types with associated content timeframes; processing the received data to modify predefined behavior-to-emotion mapping rules to generate a profile for the user comprising a personalized emotion map; and applying the personalized emotion map to the detected user behavior and the at least one expected emotion to infer the affective state of the user.

Example 25 includes the subject matter of Example 24, the operations further comprising: executing a transductive learning phase comprising: processing the user behavior, the set of expected affective-state or emotion labels, and the set of content types with associated content timeframes using a vector quantization algorithm to generate accumulated interval features; and generating an initial model for emotion mapping using a transductive learning algorithm to process the accumulated interval features and the behavior-to-emotion mapping rules; and executing an inductive learning phase comprising: updating the personalized emotion map using a machine learning algorithm to process the initial model, the user behavior, and the set of expected affective-state and/or emotion labels.

Example 26 is an apparatus including means for receiving sensor data, means for processing the sensor data to detect a user behavior as the user consumes content or interacts with a machine, means for receiving content metadata indicating a context of the content provided to the user and a probability of the user experiencing at least one expected emotion as the user consumes the content or interacts with the machine, and means for applying, based on the context and the at least one expected emotion indicated in the content metadata, one or more rules to map the detected user behavior to an affective state of the user.

Example 27 includes the subject matter of Example 26, wherein receiving the content metadata comprises receiving the content metadata from a provider of the content.

Example 28 includes the subject matter of any of Examples 26-27, and further including means for receiving interaction metadata indicating an interaction between the user and an application configured to present the content to the user; and based on the interaction metadata, means for updating the rules to map the detected user behavior to the affective state.

Example 29 includes the subject matter of Example 28, and further includes means for processing the interaction metadata to determine a plurality of contextual sub-divisions within content intervals of the content.

Example 30 includes the subject matter of any of Examples 26-29, and further includes means for parsing the content metadata into a set of expected affective state and/or emotion labels, and a set of content types with associated content timeframes, wherein the set of expected affective state and/or emotion labels are associated with a probability within each content timeframe.

Example 31 includes the subject matter of Example 30, further comprising: means for receiving data comprising the user behavior, the set of expected affective state and/or emotion labels, and the set of content types with associated content timeframes; means for processing the received data to modify predefined behavior-to-emotion mapping rules to generate a profile for the user comprising a personalized emotion map; and means for applying the personalized emotion map to the detected user behavior and the at least one expected emotion to infer the affective state of the user.

Example 32 includes the subject matter of Example 31, further comprising: means for executing a transductive learning phase comprising: processing the user behavior, the set of expected affective-state or emotion labels, and the set of content types with associated content timeframes using a vector quantization algorithm to generate accumulated interval features; and generating an initial model for emotion mapping using a transductive learning algorithm to process the accumulated interval features and the behavior-to-emotion mapping rules.

Example 33 includes the subject matter of any of Examples 32, and further includes means for executing an inductive learning phase comprising updating the personalized emotion map using a machine learning algorithm to process the initial model, the user behavior, and the set of expected affective-state and/or emotion labels.

The above description provides numerous specific details for a thorough understanding of the embodiments described herein. However, those of skill in the art will recognize that one or more of the specific details may be omitted, or other methods, components, or materials may be used. In some cases, well-known features, structures, or operations are not shown or described in detail.

Furthermore, the described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer executable code located within a memory device and/or computer-readable storage medium. A software module may, for instance, comprise one or more physical or logical blocks of computer instructions, which may be organized as a routine, program, object, component, data structure, etc., that performs one or more tasks or implements particular abstract data types. In certain embodiments, the described functions of all or a portion of a software module (or simply “module”) may be implemented using circuitry.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention. The scope of the present invention should, therefore, be determined only by the following claims.

1. A system to determine an affective state of a user, the system comprising:
a behavior feature extraction module to process information from one or more sensors to detect a user behavior characteristic, the user behavior characteristic generated in response to content provided to the user; and
an affective state recognition module to:
receive content metadata indicating a context of the content provided to the user and a probability of the user experiencing at least one expected emotion in response to an interaction with the content;
based on the context and the at least one expected emotion indicated in the content metadata, apply one or more rules to map the detected user behavior characteristic to an affective state of the user; and
output or store the affective state of the user.

2. The system of claim 1, wherein the affective state recognition module is further configured to:
receive interaction metadata indicating an interaction between the user and an application or machine configured to present the content to the user; and
based on the interaction metadata, update the rules to map the detected user behavior characteristic to the affective state.

3. The system of claim 2, wherein the content comprises a plurality of content intervals, and wherein the interaction metadata defines contextual sub-divisions within the content intervals.

4. The system of claim 1, wherein the affective state recognition module comprises a content metadata parser to receive the content metadata, and to separate the content metadata into a set of expected affective state and/or emotion labels, and a set of content types with associated content timeframes, and wherein the set of expected affective state and/or emotion labels are associated with a probability within each content timeframe.

5. The system of claim 4, wherein the affective state recognition module further comprises a learning module configured to:
receive data comprising the user behavior characteristic, the set of expected affective state and/or emotion labels, and the set of content types with associated content timeframes;
process the received data to modify predefined behavior-to-emotion mapping rules to generate a profile for the user comprising a personalized emotion map; and
apply the personalized emotion map to the detected user behavior characteristic and the at least one expected emotion to infer the affective state of the user.

6. The system of claim 5, wherein the learning module is further configured to update the personalized emotion map based on the detected user behavior characteristic and the at least one expected emotion.

7. The system of claim 5, wherein the learning module is configured to execute a transductive learning phase, the learning module comprising:
a real-time data collection module to process the user behavior characteristics, the set of expected affective-state or emotion labels, and the set of content types with associated content timeframes using a vector quantization algorithm to generate accumulated interval features; and
a transductive learning module to generate an initial model for emotion mapping, the transductive learning module using a transductive learning algorithm to process the accumulated interval features and the behavior-to-emotion mapping rules.

8. The system of claim 7, wherein the learning module is further configured to execute an inductive learning phase, the learning module further comprising:
an inductive learning module to update the personalized emotion map using a machine learning algorithm to process the initial model generated by the transductive learning module, the user behavior characteristics, and the set of expected affective-state and/or emotion labels.

9. A computer-implemented method of determining an affective state of a user, the method comprising:
receiving information from one or more sensors;
processing, on one or more computing devices, the information from the one or more sensors to detect a user behavior as the user consumes content or interacts with a machine;
receiving content metadata indicating a context of the content provided to the user and a probability of the user experiencing at least one expected emotion as the user consumes the content or interacts with the machine;
based on the context and the at least one expected emotion indicated in the content metadata, applying one or more rules to map the detected user behavior to an affective state of the user.

10. The computer-implemented method of claim 9, wherein receiving the content metadata comprises receiving the content metadata from a provider of the content.

11. The computer-implemented method of claim 9, further comprising:
receiving interaction metadata indicating an interaction between the user and an application configured to present the content to the user; and
based on the interaction metadata, updating the rules to map the detected user behavior to the affective state.

12. The computer-implemented method of claim 11, further comprising: processing the interaction metadata to determine a plurality of contextual sub-divisions within content intervals of the content.

13. The computer-implemented method of claim 9, further comprising:
parsing the content metadata into a set of expected affective state and/or emotion labels, and a set of content types with associated content timeframes,
wherein the set of expected affective state and/or emotion labels are associated with a probability within each content timeframe.

14. The computer-implemented method of claim 13, further comprising:
receiving data comprising the user behavior, the set of expected affective state and/or emotion labels, and the set of content types with associated content timeframes;
processing the received data to modify predefined behavior-to-emotion mapping rules to generate a profile for the user comprising a personalized emotion map; and
applying the personalized emotion map to the detected user behavior and the at least one expected emotion to infer the affective state of the user.

15. The computer-implemented method of claim 14, further comprising:
executing a transductive learning phase comprising:
processing the user behavior, the set of expected affective-state or emotion labels, and the set of content types with associated content timeframes using a vector quantization algorithm to generate accumulated interval features; and
generating an initial model for emotion mapping using a transductive learning algorithm to process the accumulated interval features and the behavior-to-emotion mapping rules.

16. The computer-implemented method of claim 15, further comprising:
executing an inductive learning phase comprising updating the personalized emotion map using a machine learning algorithm to process the initial model, the user behavior, and the set of expected affective-state and/or emotion labels.

17. At least one computer-readable storage medium having stored thereon instructions that, when executed by a processor, cause the processor to perform operations comprising:
receiving information from one or more sensors;
processing, on one or more computing devices, the information from the one or more sensors to detect a user behavior as the user consumes content or interacts with a machine;
receiving content metadata indicating a context of the content provided to the user and a probability of the user experiencing at least one expected emotion as the user consumes the content or interacts with the machine;
based on the context and the at least one expected emotion indicated in the content metadata, applying one or more rules to map the detected user behavior to an affective state of the user.

18. The at least one computer-readable storage medium of claim 17, wherein receiving the content metadata comprises receiving the content metadata from a provider of the content.

19. The at least one computer-readable storage medium of claim 17, the operations further comprising:
receiving interaction metadata indicating an interaction between the user and an application configured to present the content to the user; and
based on the interaction metadata, updating the rules to map the detected user behavior to the affective state.

20. The at least one computer-readable storage medium of claim 19, the operations further comprising:
processing the interaction metadata to determine a plurality of contextual sub-divisions within content intervals of the content.

21. The at least one computer-readable storage medium of claim 17, the operations further comprising:
parsing the content metadata into a set of expected affective state and/or emotion labels, and a set of content types with associated content timeframes, wherein the set of expected affective state and/or emotion labels are associated with a probability within each content timeframe.

22. The at least one computer-readable storage medium of claim 21, the operations further comprising:
receiving data comprising the user behavior, the set of expected affective state and/or emotion labels, and the set of content types with associated content timeframes;
processing the received data to modify predefined behavior-to-emotion mapping rules to generate a profile for the user comprising a personalized emotion map; and
applying the personalized emotion map to the detected user behavior and the at least one expected emotion to infer the affective state of the user.

23. The at least one computer-readable storage medium of claim 22, the operations further comprising:
executing a transductive learning phase comprising:
processing the user behavior, the set of expected affective-state or emotion labels, and the set of content types with associated content timeframes using a vector quantization algorithm to generate accumulated interval features; and
generating an initial model for emotion mapping using a transductive learning algorithm to process the accumulated interval features and the behavior-to-emotion mapping rules.

24. The at least one computer-readable storage medium of claim 23, the operations further comprising:
executing an inductive learning phase comprising updating the personalized emotion map using a machine learning algorithm to process the initial model, the user behavior, and the set of expected affective-state and/or emotion labels.
